(19) United States
(12) Patent Application Publication
(10) Pub. No.: US 2005/0263964 A1
(43) Pub. Date: Dec. 1, 2005

(54) Tracking apparatus

(75) Inventor: Kazunari Kumoi, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Mitsubishi Denki Kabushiki Kaisha, Tokyo (JP)

(21) Appl. No.: 10/965,843

(22) Filed: Oct. 18, 2004

(30) Foreign Application Priority Data
May 14, 2004 (JP) 2004-145297

(51) Int. Cl. F16M 13/00; B60D 5/00

(52) U.S. Cl. 280/5.5; 248/566

(57) ABSTRACT

A tracking apparatus includes: a fixing frame secured on a platform, and supporting a main body; a turning frame supported by the fixing frame, and rotating in one direction on the supported position as a rotation axis; an elevating frame connected with one end of the turning frame, and rotating in a direction different from the direction where the turning frame rotates; a sensor mounted on the elevating frame, and the pointing direction of which is determined based on the rotation angles of the turning frame and the elevating frame; a turning balance weight provided on the end of the turning frame, which is opposite the elevating frame, to keep the balance of the rotation axis of the turning frame; an elevating balance weight provided on the elevating frame to keep the balance of the rotation of the elevating frame; and a damper provided between the turning frame and the turning balance weight.

### BACKGROUND OF THE INVENTION

1. Field of the Invention

The present invention relates to a tracking apparatus mounted on a movable body.

2. Description of the Related Art

A movable body such as a motor vehicle, vessel, or aircraft receives influences from the outside world such as road irregularities, ocean waves, changes in the atmospheric pressure, and wind and rain, and thereby is always vibrating. The vibration and rocking of such a movable body itself are transmitted to a tracking apparatus such as an antenna mounted on the movable body. For this reason, there is a problem that when the tracking apparatus is an antenna, for example, the pointing accuracy of the antenna for transmitting and receiving the radio beam reduces, and when the tracking apparatus is an image pickup machine, the visual axis of the machine may deviate.

In order for a tracking device to always point in a determined direction on a movable body (platform) that always changes its attitude by vibrating, rocking, and the like, it is necessary to move the pointing axis of the tracking device in the opposite direction of the movement of the platform to be canceled out. Therefore, the technology has been proposed that stabilizes the pointing direction of a tracking device (apparatus) by providing a mechanism such as a drive motor that can move the sensor and the sensor axis of the tracking device in vertical and horizontal directions, and thereby moving the axis in the opposite direction of the movement of the platform.

For example, JP-A-2002-135019 discloses a conventional antenna device for a movable body such that an attitude sensor for controlling its antenna and the beam-pointing direction of the antenna is secured on its antenna structure, and that the antenna structure is mounted on the movable body to be isolated from the vibration.

Moreover, a conventional tracking apparatus is arranged such that the speed at which its axis is driven is increased, and the band of the vibration frequency to be controlled is widened, thereby minimizing the deviation of the pointing axis.

The rocking and vibration of a movable body that is a platform includes a variety of frequency components.

Meanwhile, because a structure composing a tracking apparatus includes an elastic body with rigidity, the structure has at least one natural frequency.

Therefore, when a vibration at the natural frequency is transmitted to the tracking apparatus, the structure composing the tracking apparatus receives the vibration to produce a resonance phenomenon. In this case, the vibration of the tracking apparatus is amplified, and the apparatus vibrates with an amplitude that is larger than that of the vibration transmitted from the platform.

In general, the natural frequency of a structure composing a tracking apparatus is often approximately 50-100 Hz. However, it is the vibration of approximately 20-30 Hz or less that can be corrected by use of a usual drive motor. Consequently, it is difficult to control the vibration of the tracking apparatus at the time of a resonance by using a drive mechanism.

Briefly, there is a problem that it is necessary to suppress the vibration of a tracking mechanism at the time of resonance by using a method other than a drive mechanism.

### SUMMARY OF THE INVENTION

The present invention has been accomplished to solve the above-mentioned problem. An object of the present invention is to prevent the reduction of the pointing accuracy of a tracking apparatus mounted on a movable body because of its vibration.

A tracking apparatus to be mounted on a movable body according to the present invention includes: a fixing frame, secured on the movable body, for supporting a main body of the apparatus; a first turning frame supported by the fixing frame, and rotatable in one direction on the supported position as a rotation axis; a second turning frame connected on one end of the first turning frame, and rotatable in a direction that is different from the direction of the first turning frame; a sensor that is mounted on the second turning frame, and the pointing direction of which is determined with respect to a target based on a rotation angle of the first turning frame and a rotation angle of the second turning frame; a first turning balance weight provided on the opposite end of the first turning frame from the second turning frame to keep the balance of a rotation axis of the first turning frame; a second turning balance weight provided on the second turning frame to keep the balance of a rotation axis of the second turning frame; and an elastic body that is provided between the first turning frame and the first turning balance weight, and the elasticity of which is adjusted such that a natural frequency on the side of the first turning frame including the sensor with the rotation axis of the first turning frame as a boundary conforms with the one on the side of the first turning frame including the first turning balance weight with the rotation axis thereof as a boundary.

Therefore, according to the present invention, the rigidity of the first turning frame is adjusted by interposing the elastic body between the first turning frame and the first turning balance weight, and thereby the natural frequencies on the front and rear sides of the turning frame conform with each other. in such a way, when a vibration at the frequency equal to the natural frequency of the frame is transmitted from the movable body to be mounted, the first turning balance weight and the sensor can vibrate in the same direction, thereby minimizing the rocking of the first turning frame. Therefore, the reduction of the pointing accuracy of the sensor can be suppressed.

### BRIEF DESCRIPTION OF THE DRAWINGS

FIGS. 1A and 1B are views showing the configuration of a tracking apparatus in accordance with a first embodiment of the present invention;

FIGS. 2A-2C are explanatory diagrams of the operation of the tracking apparatus in accordance with the first embodiment of the present invention upon an occurrence of a resonance phenomenon when the resonance frequencies on the front and rear sides of the turning frame conform with each other;

FIGS. 3A-3C are explanatory diagrams of the operation of the tracking apparatus upon an occurrence of a resonance phenomenon when the resonance frequencies on the front and rear sides of the turning frame are different from each other;

FIG. 4 is a view of the damper portion of a tracking apparatus in accordance with a second embodiment of the present invention;

FIG. 5 is a view of the damper portion of a tracking apparatus in accordance with a third embodiment of the present invention;

FIG. 6 is a view of the damper portion of a tracking apparatus in accordance with a fourth embodiment of the present invention; and

FIGS. 7A and 7B are views of the damper portion of a tracking apparatus in accordance with a fifth embodiment of the present invention.

### DETAILED DESCRIPTION OF THE PREFERRED EMBODIMENTS

An embodiment of the present invention will be described below.

### First Embodiment

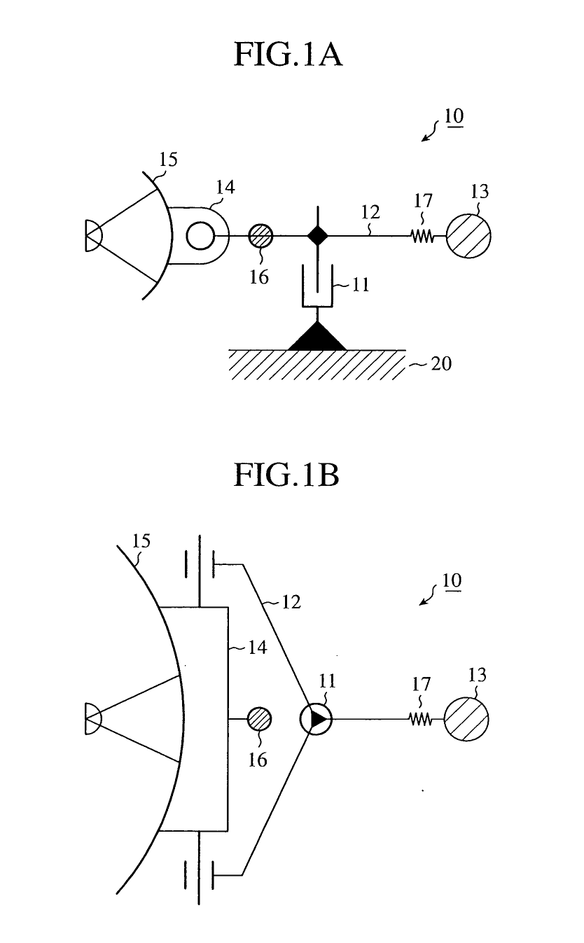

FIGS. 1A and 1B are views showing the configuration of a tracking apparatus 10 in accordance with a first embodiment of the present invention. The tracking apparatus 10 includes a fixing frame 11, a turning frame (first turning frame) 12, a turning balance weight (first turning balance weight) 13, an elevating frame (second turning frame) 14, a sensor 15, an elevating balance weight (second turning balance weight) 16, and a damper (elastic body) 17.

The tracking apparatus 10 is mounted on the platform 20 of an aircraft and the like, and the apparatus includes the sensor 15 having the function of observing a target, such as a communications antenna or a camera, for example.

A main body of the tracking apparatus 10 is fixed or secured on the platform 20 by means of the fixing frame 11. The tracking apparatus 10 is schemed to determine a direction where the sensor 15 points based on rotations in two directions. A first rotating direction is a direction that is horizontal with respect to the fixed face of the fixing frame 11 (hereinafter referred to as the horizontal direction). FIG. 1A is a view of the tracking apparatus 10 as seen from the horizontal direction, and FIG. 1B is a view of the tracking apparatus 10, looking down from the perpendicular direction with respect to the platform 20. A second rotating direction is a direction that is a “looking down or looking up” direction (hereinafter referred to as the “elevating” direction) with respect to the plane rotating in the horizontal direction.

The turning frame 12 is supported by the fixing frame 11, and can horizontally rotate on a position at which the frame is supported as a rotation axis. The rotation of the turning frame 12 determines the pointing direction of the sensor 15 in its horizontal direction.

The elevating frame 14 is mounted on one end of the turning frame 12, and can rotate in the elevating direction. The elevating frame 14 is equipped with the elevating balance weight 16 for keeping the balance of the rotation axis of the elevating frame 14. The sensor 15 is fixed on the elevating frame 14. The rotation of the elevating frame 14 determines the pointing direction of the sensor 15 in the elevating direction.

On the other end of the turning frame 12, the turning balance weight 13 is mounted through the damper 17 for keeping the balance of the rotation axis of the turning frame 12. The damper 17 is an elastic body with a buffering property.

Moreover, the tracking apparatus 10 is equipped with a driving device (not shown) that controls the direction where the sensor 15 points.

The operation will now be described as below.

When the platform 20 vibrates with a movement, the vibration is transmitted to the tracking apparatus 10 via the fixing frame 11. When the vibration is transmitted to the tracking apparatus 10, a deviation is caused in the pointing direction of the sensor 15. The driving device of the tracking apparatus 10 controls the direction of the sensor 15 in a direction where the deviation can be canceled.

It is now proposed to consider the case in which a vibration at the frequency that is equal to the natural frequency of the turning frame 12 is transmitted to the frame. The turning frame 12 causes a resonance phenomenon and thereby vibrates with an amplitude that is larger than that of the vibration transmitted from the platform 20.

Now, let the side of the turning frame 12, including the elevating frame 14 and the sensor 15, as seen from the fulcrum on which the turning frame 12 is fixed on the fixing frame 11, be the front side of the turning frame 12, and let the side thereof including the turning balance weight 13 be the rear side of the turning frame 12. The front side of the turning frame 12 resonates at the natural frequency determined by the rigidities and weights of the turning frame 12 itself, the sensor 15, and the elevating frame 14. The rear side of the turning frame 12 resonates at the natural frequency determined by the rigidities and weights of the turning frame 12 itself, the turning balance weight 13, and the damper 17.

At that time, if the natural frequencies on the front and rear sides of the turning frame 12 do not conform with each other, the two sides thereof will rock in respective independent modes. Therefore, because the structure rocks in the phase that is opposite to that of the input vibration upon an occurrence of a resonance phenomenon on the one side of the turning frame 12, the other side of the turning frame 12 will vibrate in the opposite direction.

In the first embodiment, the damper 17 is provided between the turning frame 12 and the turning balance weight 13 to be adjusted so that the front and rear sides of the turning frame 12 can have the same resonance frequency. In other words, the rigidity of the rear side of the turning frame 12 is adjusted by use of the damper 17, to thereby cause a resonance phenomenon to produce at the same time on the front side and the rear side of the turning frame 12.

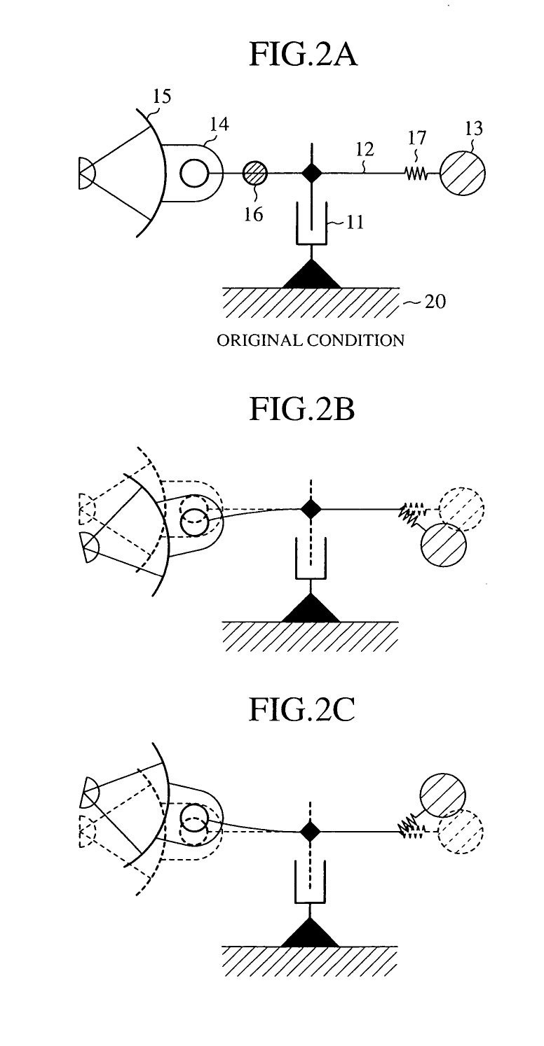

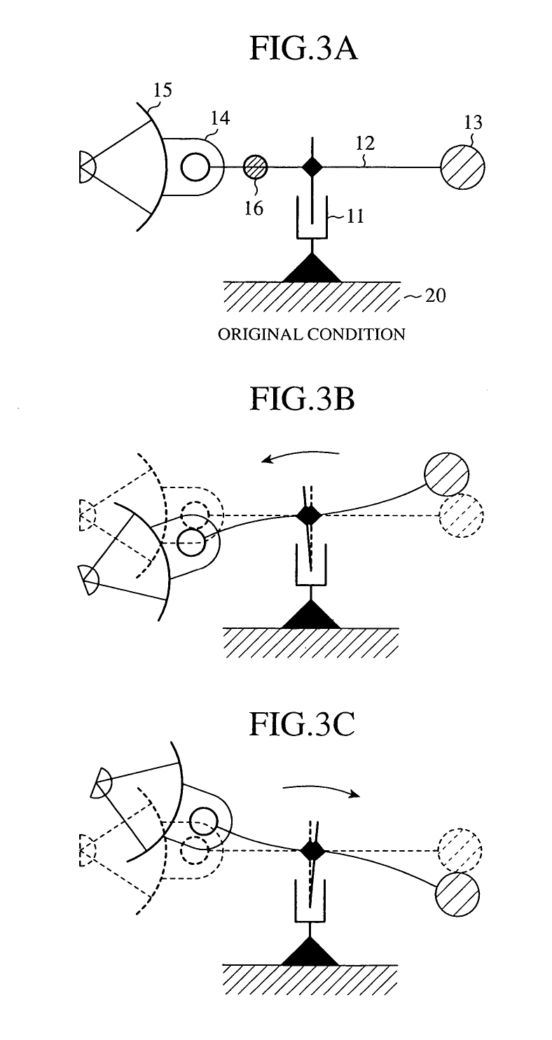

FIGS. 2A-2C are explanatory diagrams of the operation of the tracking apparatus 10 in accordance with the first embodiment upon an occurrence of a resonance phenomenon when the resonance frequencies on the front and rear sides of the turning frame 12 conform with each other. FIGS. 3A-3C are explanatory diagrams of the operation of the tracking apparatus 10 upon an occurrence of a resonance phenomenon when the resonance frequencies on the front and rear sides of the turning frame 12 are different from each other.

As shown in FIGS. 3A-3C, no damper 17 is provided between the turning frame 12 and the turning balance weight 13, and the natural frequencies on the front and rear sides of the turning frame 12 do not conform with each other. In this case, when the front side or the rear side of the turning frame 12 produces a resonance and bends in a vertical direction, the supporting portion of the turning frame 12 located at the center of the frame inclines, and the opposite side of the turning frame 12 bends in the opposite direction. Therefore, the whole turning frame 12 inclines, and the inclination causes the inclination of the axis of the sensor 15, resulting in the deviation of the pointing direction thereof.

On the other hand, in a case shown in FIGS. 2A-2C, because the resonance frequencies on the front and rear sides of the turning frame 12 conforms with each other, the front and rear sides thereof generate a resonance at the same time, and these two sides bend in the same direction. For this reason, the inclination of the turning frame 12 is small, which enables to reduce the deviation in the pointing direction of the sensor 15.

As mentioned above, according to the first embodiment, the damper 17 is prepared between the turning balance weight 13 and the turning frame 12, and thereby the tracking apparatus is arranged such that the front and rear sides of the turning frame 12 have the same resonance frequency. Therefore, when the turning frame 12 produces a resonance, the sensor 15 and the turning balance weight 13 vibrate in the same direction, thereby reducing the inclination of the turning frame 12 to a minimum. In such a way, the pointing direction of the sensor 15 can be stably held.

Moreover, because the damper 17 provided between the turning frame 12 and the turning balance weight 13 has a buffering property, the amplitude upon a resonance can be suppressed to a low level.

Furthermore, the turning frame 12 itself is not formed of an elastic material, and the damper 17 that is an elastic body is interposed between the turning frame 12 and the turning balance weight 13. Therefore, the strength of the frame itself can be retained, and the stability of the tracking apparatus 10 can be maintained.

### Second Embodiment

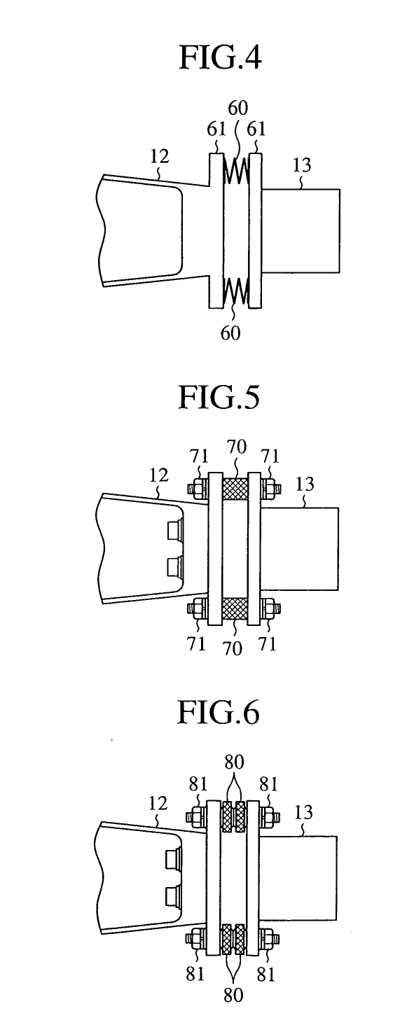

FIG. 4 is a view of the damper portion of a tracking apparatus in accordance with a second embodiment of the present invention, as seen from the same direction as that of FIG. 1A. The same numerals as those in FIGS. 1A and 1B designate the same constituent elements.

In the second embodiment, a coil spring is used for the elastic body constituting the damper.

As shown in FIG. 4, the damper portion in accordance with the second embodiment has a coil spring 60 and a stopper 61 that fixes the coil spring 60 on the turning frame 12 and the turning balance weight 13.

The connection of the turning frame 12 and the turning balance weight 13 by use of the coil spring 60 with elasticity performs a function of the damper portion.

### Third Embodiment

FIG. 5 is a view of the damper portion of a tracking apparatus in accordance with a third embodiment of the present invention, as seen from the same direction as that of FIG. 1A. The same numerals as those in FIGS. 1A and 1B designate the same constituent elements.

In the third embodiment, a rubber damper is used for the elastic body constituting the damper.

As shown in FIG. 5, the damper portion in accordance with the third embodiment has a rubber damper 70 and a nut 71 that fixes the rubber damper 70 on the turning frame 12 and the turning balance weight 13.

The connection of the turning frame 12 and the turning balance weight 13 by use of the rubber damper 70 with elasticity performs a function of the damper portion.

### Fourth Embodiment

FIG. 6 is a view of the damper portion of a tracking apparatus in accordance with a fourth embodiment of the present invention, as seen from the same direction as that of FIG. 1A. The same numerals as those of FIGS. 1A and 1B designate the same constituent elements.

In the fourth embodiment, a Belleville spring is used for the elastic body constituting the damper.

As shown in FIG. 6, the damper portion in accordance with the fourth embodiment has a Belleville or disc spring 80 and a bolt 81 that fixes the Belleville spring 80 on the turning frame 12 and the turning balance weight 13.

The connection of the turning frame 12 and the turning balance weight 13 by use of the Belleville spring 80 with elasticity may perform a function of the damper portion.

Moreover, the spring constant can be adjusted by changing the number of the Belleville springs 80 to be stacked. When the Belleville springs 80 are stacked, the sliding friction will be produced between the stacked Belleville springs 80. The friction may produce a damping force to reduce the amplification ratio at the time of a resonance.

### Fifth Embodiment

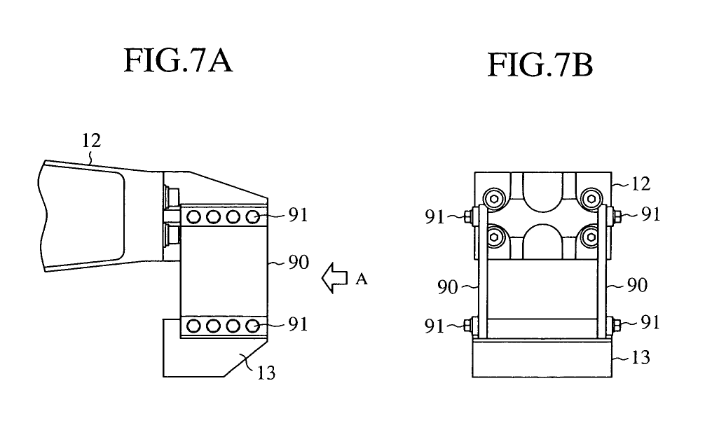

FIGS. 7A and 7B are views of the damper portion of a tracking apparatus in accordance with a fifth embodiment of the present invention. FIG. 7A is a view of the damper portion, as seen from the same direction as that of FIG. 1A, and FIG. 7B is a view of the damper portion, as seen from a direction of A. The same numerals as those in FIGS. 1A and 1B designate the same constituent elements.

In the fifth embodiment, a plate spring is used for the elastic body constituting the damper.

As shown in FIGS. 7A and 7B, the damper portion in accordance with the fifth embodiment has a plate spring 90 and set screws 91 that fix the plate spring 90 on the turning frame 12 and on the turning balance weight 13.

The connection of the turning frame 12 and the turning balance weight 13 by use of the plate spring 90 with elasticity performs a function of the damper portion.

In addition, the spring constant can be adjusted by changing the number of the plate springs 90 to be stacked. Also when the plate springs 90 are stacked, a sliding friction will be produced between the stacked plate springs 90. The friction produces a damping force to reduce the amplification ratio upon a resonance.

Moreover, the securement of the plate springs 90 thereon as shown in FIGS. 7A and 7B enables the damper effect to be given just in the vertical direction. Thus, while holding the horizontal natural frequency of the apparatus, only the vertical natural frequency thereof can be adjusted.

1. A tracking apparatus comprising:
a fixing frame, secured on a movable body, for supporting a main body;
a first turning frame supported by the fixing frame, and rotatable in one direction on the supported position as a rotation axis;
a second turning frame connected on one end of the first turning frame, and rotatable in a direction that is different from the direction of the first turning frame;
a sensor that is mounted on the second turning frame, and the pointing direction of which is determined with respect to a target based on rotation angles of the first and second turning frames;
a first turning balance weight provided on the opposite end of the first turning frame from the second turning frame to keep the balance of a rotation axis of the first turning frame;
a second turning balance weight provided on the second turning frame to keep the balance of a rotation axis of the second turning frame; and
an elastic body that is provided between the first turning frame and the first turning balance weight, and the elasticity of which is adjusted such that a natural frequency on the side of the first turning frame including the sensor with the rotation axis of the first turning frame as a boundary conforms with the one on the side of the first turning frame including the first turning balance weight with the rotation axis thereof as a boundary.

2. A tracking apparatus according to claim 1, the elastic body includes any one of a coil spring, a rubber damper, a Belleville spring, and a leaf spring.
